(19) United States
(12) Patent Application Publication
(10) Pub. No.: US 2025/0277101 A1
(43) Pub. Date: Sep. 4, 2025

(54) BIOBASED AND COMPOSTABLE PLASTICIZING AND TOUGHENING AGENT COMPOSITIONS FOR POLY LACTIC ACID (PLA), ITS RESIN COMPOSITIONS AND MAKING THEREOF

(71) Applicant: Erthos Inc., Mississauga (CA)

(72) Inventors: Emmanuel Olusegun OGUNSONA, Mississauga (CA); Nima ZARRINBAKHSH, Mississauga (CA); Shadi MESHKAT ALSADAT, Mississauga (CA); Devni Nayanathara ELAMALDENIYA, Mississauga (CA)

(21) Appl. No.: 19/064,219

(22) Filed: Feb. 26, 2025

Related U.S. Application Data
(60) Provisional application No. 63/560,391, filed on Mar. 1, 2024.

(51) Int. Cl. C08K 5/00; C08K 3/26; C08K 5/092; C08K 5/14; C08L 67/04

(52) U.S. Cl. CPC C08K 5/0016; C08K 3/26; C08K 5/092; C08K 5/14; C08L 67/04; C08K 2003/265; C08L 2201/06

(57) ABSTRACT

The invention is a range of biobased and biodegradable compositions used as an additive to impart plasticization and toughness to polylactic acid (PLA) of all grades, forms, molecular weights or compositions thereof, when blended using any contemporary form of compounding techniques such as single and twin screw extrusion and batch mixing. It encompasses at least one lipid, one oxidizer, and optionally one acidifier. The plasticizer compositions encompass functional groups, which may represent the following but not limited to carboxyls, carbonyls, epoxides and anhydrides. Different tiers of the plasticizer compositions of the invention exhibit different levels of toughening and plasticizing efficacy on the polylactic acid polyesters and its resin compositions. The toughening and plasticizing effects of the invention on polylactic acid is observed from the multi-fold increase in tensile toughness, elongation at break and impact strength. This additive can alter the physical and mechanical properties of PLA, allowing its use in wider applications similar to those used for film, thermoforming, profile extrusion and injection molding applications, where environmental concerns are of key importance due to the effects hazardous and petroleum based additives, used to achieve similar properties of PLA, have on the environment during the end-of-life composting.

### CROSS-REFERENCE TO RELATED APPLICATIONS

This application claims the benefit of U.S. Provisional Application No. U.S. 63/560,391, filed Mar. 1, 2024, which is hereby incorporated by reference in its entirety.

### FIELD OF INVENTION

The present invention relates to the development of biobased and biodegradable plasticizing and toughening agent compositions for polylactic acid and its resin compositions, which allows for a wider range of applications in areas such as extruded films, sheets, and profiles as well as injection molded or thermoformed rigid parts, within which the elongation at break and impact strength of the PLA is improved by more than 1680% and more than 100%, respectively. Moreso, the invention is directed towards the use of a specified weight percentage ranges of the ingredients, and protocols for the production of biobased and biodegradable plasticizer compositions.

### BACKGROUND OF THE INVENTION

Plasticizers are the most common plastics additives, with the primary role of enhancing polymer flexibility, processability and durability, typically by decreasing the glass transition temperature and enhancing molecular chain mobility. Despite the technology having been around for about a century, there is an ongoing quest to find more effective, less expensive, and more environmentally-friendly plasticizers for petroleum-based and bio-based polymers. Along with the global interest and push for the transition from conventional petroleum-based plastics to bioplastics, a critical demand has arisen for fully bio-based plasticizers that exhibit compatibility with bioplastics as well as efficacy to serve as an alternative to synthetically produced plasticizers such as phthalates, which are the most widely used plasticizers. Poly lactic acid, recognized as the foremost biodegradable bioplastic, is the most investigated bioplastic in terms of developing suitable plasticizers for. PLA exhibits good mechanical and optical properties. However, it suffers from high brittleness and low toughness. Polyalkylene glycols (PEG and PPG) are the most popular plasticizers for PLA, even though petroleum-based, are biodegradable and have high miscibility and compatibility with PLA. PEG concentration in PLA as low as 7 wt. %, results in a significant ten-fold increase in the elongation of PLA [1]. However, the synthetic nature of this plasticizer impedes its application as a sustainable additive for PLA. Citrate esters including acetyl tributyl citrate (ATBC), tributyl citrate (TBC), and triethyl citrate (TEC) are promising commercialized plasticizers for PLA. Despite being partially bio-based and biodegradable, the process of manufacture is very complex, involving multiple stages that incorporate reactive distillation. The homogeneous catalysts employed in the reaction are usually harsh and aggressive acids such as sulfuric acid, which is mostly preferred for its high reactivity to obtain a high yield [2]. Nevertheless, its corrosive nature, formation of by-products, and challenges associated with its recycling, present complexities, particularly as it often persists in the final product [3]. Citrates also suffer from low thermal stability and low migration resistance [4]. A range of aliphatic esters including adipates and sebacates have also been explored as PLA plasticizers. Despite boosting impact strength, they are partially biobased and ineffective in low concentrations [5], [6]. Thus, there is a need for fully bio-based and biodegradable plasticizers for bioplastics with environmentally friendly production methods, which are as or more efficient as the existing plasticizers.

### SUMMARY OF INVENTION

The invention encompasses bio-based, biodegradable and compostable plasticizer compositions which enhance the flexibility and toughness of biodegradable thermoplastic polyester resins based on polylactic acid (PLA) when directly employed through the melt-blending process. The toughened and plasticized polylactic acids demonstrate enhanced processability by means of increased melt flow index and mechanical properties by means of increased elongation at break and impact strength, when compared to virgin polylactic acid.

In certain embodiments, the procedures for the synthesis of the compostable plasticizing agents, as well as the melt blending process with the biodegradable thermoplastic polyester in specific weight ratios are provided. The formulated blend compositions are capable of being remelted and reshaped using various techniques, such as injection molding, compression molding, and cast film extrusion, enabling the formation of a range of rigid polymeric materials for different applications.

In certain embodiments, the development of compostable plasticizers extends to all the range of the chain lengths, degrees of saturation and functionalities of biodegradable lipids from different sources. In other embodiments, the synthesis of biodegradable plasticizer extends various degrees of crosslinking and degree of oxidation. The blend development process extends the range of molecular weights and grades of polylactic acid that can be used and melt-blended at various weight ratios with different ratios of the compostable plasticizers.

In one embodiment, the invention encompasses a composition comprising a compostable plasticizer that is the product of an oxidation reaction of at least one biodegradable lipid including oils obtained from sources such as vegetables, nuts, grains, seeds, animals, etc. Examples of lipids include but are not limited to fats and oils, waxes (soy wax, stearate wax, bees wax, lanolin, chinese wax, spermaceti wax, carnauba wax), saturated and unsaturated fatty acids, triglycerides, triacylglycerols, phospholipids, glycolipids, glycerol and sphingosine, and can be sourced from animals by-products and plants such as but not limited to soybean, peanut, vegetables, linseed, castor, palm, corn, olive, canola and pecan. Lipids can be used in their virgin or post modification form. Lipids can have or be saturated, mono unsaturated, polyunsaturated fatty acids, or a combination thereof. These fatty acids can include but are not limited to linoleic acid, stearidonic acid, erucic acid, oleic acid, linolenic acid, palmitic acid, palmitoleic acid, vaccenic acid, gondoic acid, nervonic acid, cetoleic acid, myristoleic acid, petroselinic acid, ximenic acid, or a combination thereof.

In one embodiment, the oxidation reaction occurs in the presence of 0 to 40 weight percent of one or more acidifiers including but not limited to lactic acid, formic acid, stearic acid, tannic acid, malic acid, citric acid, aspartic acid, ascorbic acid, acetic acid, tartaric acid. In various embodiments, the amount of one or more of the acidifiers used is about 0%, 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In one embodiment, the oxidation reaction occurs in the presence of 0.01 to 40 weight percent of one or more oxidizers including but not limited to potassium permanganate, nitric acid, hydrogen peroxide, peracetic acid, zinc peroxide, perchlorate, potassium chlorate, nitrous oxide, bromine, ozone and fluorine. In various embodiments, the amount of one or more of the oxidizers used is about 0.01%, 0.05%, 0.1%, 0.2%, 0.3%, 0.4%, 0.5%. 0.6%, 0.7%, 0.8%, 0.9%, 1%, 2%, 3%, 4%, 5%, 6%, 7%, 8%, 9%, 10%, 12.5%, 15%, 17.5%, 20%, 22.5%, 25%, 27.5%, 30%, 32.5%, 35%, 37.5%, or about 40%.

In one embodiment, the plasticizer is produced by synthesis of one lipid with one acidifier and one oxidizer.

In one embodiment, the plasticizer is produced by synthesis of one or more lipids with one acidifier and one oxidizer.

In one embodiment, the plasticizer is produced by synthesis of one or more lipids with one or more acidifiers and one oxidizer.

In one embodiment, the plasticizer is produced by synthesis of one or more lipids with one acidifier and one or more oxidizer.

In one embodiment, the plasticizer is produced by synthesis of one or more lipids with one or more acidifiers and one or more oxidizer.

In one embodiment, the plasticizer is produced by synthesis of one or more lipids with one or more acidifiers and one or more oxidizer, then later synthesized with one or more of either acidifier and/or oxidizer.

In one embodiment, the plasticizer is produced by synthesis of one or more lipids with and one or more oxidizer.

In certain embodiments, the method for the production of the biobased and biodegradable plasticizer can be any of the following but not limited to the use of at least a lipids, and an oxidizer, and optionally other additives including, but not limited to acidifiers, initiators, stabilizers, etc. In various embodiments, the lipids to acidifier molar ratio, ranging from about 0.01 to about 3.00 is employed. In various embodiments, the ratio is of the lipids to acidifiers is about 0.01, 0.05, 0.10, 0.15, 0.20, 0.25, 0.30, 0.35, 0.40, 0.50, 0.55, 0.60, 0.65, 0.70, 0.75, 0.80, 0.85, 0.90, 0.95, 1.00, 1.25, 1.50, 1.75, 2.00, 2.25, 2.50, 2.75, or about 3.00.

In one embodiment, the reactants are premixed in a reaction vessel and then raised to a desired temperature. In another scenario, the acidifier is heated before the addition of lipids, oxidizer and other optional additives under stirring in a reaction vessel. In another scenario, the lipids, oxidizer and other optional additives are premixed prior to the addition of an acidifier. In another scenario, the acidifier and lipids are mixed and heated to a specific temperature before the addition of oxidizer and any other optional additives.

In certain embodiments, the reaction vessel could be made of heat and crack-resistant glassware, chemical resistant coated stainless steel or high-temperature-resistant plastic, equipped with an overhead or an internal stirrer. The temperature of the mixture is increased and maintained to the desired reaction temperatures at every stage of the reaction. The reaction is cooled slowly or rapidly and considered complete after a period ranging from a few minutes to a few hours.

In certain embodiments, the reaction is set at temperatures ranging from 50 to 250° C. Reagents are agitated from the point of mixture and at room temperature. In another scenario, the agitation is started after the reagents are heated to a desired temperature and maintained for a prescribed period. The reaction is continued until the desired time period is expended. In another scenario, the agitation is increased or decreased at different stages of the reaction.

In certain embodiments, the lipid is one or a combination of any of the following: a saturated, mono unsaturated, polyunsaturated fatty acids, or combination thereof. These fatty acids can include but are not limited to short, medium and long chain carbon and a combination thereof, etc.

In one embodiment, the lipid is a mixture of sesame oil and peanut oil.

In one embodiment, the lipid is a mixture of coconut oil and cottonseed oil.

In one embodiment, the lipid is a mixture of corn oil and olive oil.

In one embodiment, the lipid is a mixture of coconut oil and sesame oil.

In one embodiment, the lipid is a mixture of sunflower oil and canola oil.

In one embodiment, the lipid is a mixture of soybean oil and palm oil.

In one embodiment, the lipid is a mixture of corn oil and linseed oil.

In one embodiment, the lipid is a mixture of rapeseed oil and palm oil.

In one embodiment, the lipid is a mixture of peanut oil and safflower oil.

In one embodiment, the lipid is a mixture of brazil nut oil and cashew oil.

In one embodiment, the lipid is a mixture of almond oil and pecan oil.

In one embodiment, the lipid is a mixture of pine nut oil and macadamia oil.

The embodiments are not limited to binary combinations of lipids, but could encompass combinations of three or more of the lipids.

In certain embodiments, the invention encompasses a plasticizer which is of a very high viscosity.

In certain embodiments, the invention encompasses a plasticizer which is of a very low viscosity.

In one embodiment, the plasticizer is purified immediately after synthesis.

In one embodiment, the plasticizer is purified after synthesis and cooling down.

In one embodiment, the plasticizer is used without purification.

In certain embodiments, the biodegradable resin compositions from the blends of the biobased and biodegradable plasticizer of the invention with polylactic acid can be used in various embodiments from single-use products to durable products and in a wide range of applications, from packaging to medical, consumer products and many more.

In one embodiment, the resin blend is a composition of one PLA with one plasticizer of the invention.

In one embodiment, the resin blend is a composition of one PLA with two or more plasticizers of the invention.

In one embodiment, the resin blend is a composition of two or more PLA with one plasticizer of the invention.

In one embodiment, the resin blend is a composition of two or more PLA with two or more plasticizers of the invention.

In one embodiment, the resin blend is a composition of one PLA with one plasticizer of the invention and one or more fillers.

In one embodiment, the resin blend is a composition of one PLA with two or more plasticizers of the invention and one or more fillers.

In one embodiment, the resin blend is a composition of two or more PLA with one plasticizer of the invention and one or more fillers.

In one embodiment, the resin blend is a composition of two or more PLA with two or more plasticizers of the invention and one or more fillers.

In one embodiment, the resin blend is a composition of one PLA with one plasticizer of the invention and one or more additives.

In one embodiment, the resin blend is a composition of one PLA with two or more plasticizers of the invention and one or more additives.

In one embodiment, the resin blend is a composition of two or more PLA with one plasticizer of the invention and one or more additives.

In one embodiment, the resin blend is a composition of two or more PLA with two or more plasticizers of the invention and one or more additives.

In one embodiment, the resin blend is a composition of one PLA with one plasticizer of the invention and one or more fillers and one or more additives.

In one embodiment, the resin blend is a composition of one PLA with two or more plasticizers of the invention and one or more fillers and one or more additives.

In one embodiment, the resin blend is a composition of two or more PLA with one plasticizer of the invention and one or more fillers and one or more additives.

In one embodiment, the resin blend is a composition of two or more PLA with two or more plasticizers of the invention and one or more fillers and one or more additives.

In certain embodiments, the biodegradable plasticizer of the invention exhibits a bio-based carbon content of up to 100%.

In certain embodiments, biodegradable compositions from the blends of the biodegradable plasticizer of the invention with polylactic acid exhibit a bio-based carbon content of up to 100%.

In certain embodiments, biodegradable compositions from the blends of the biodegradable plasticizer of the invention with polylactic acid exhibit an MFI (melt flow index) of as high as 11 g/10 min measured at 2.16 kg and 190° C.

In certain embodiments, biodegradable compositions from the blends of the plasticizer of the invention with polylactic acid exhibit an elongation at break as high as 95% when tested at a strain rate of 50 mm/min.

In certain embodiments, biodegradable compositions from the blends of the plasticizer of the invention with polylactic acid exhibit an impact strength as high as 65 J/m.

In various embodiments, the biobased and biodegradable plasticizer of the invention encompass compositions comprising:
a. about 50 to about 90% (w/w) of one or more lipids;
b. about 0 to about 40% (w/w) of one or more acidifiers;
c. about 0.01 to about 40% (w/w) of one or more oxidizers;
d. about 0 to about 10% (w/w) of one or more of stabilizers;
In various embodiments, biodegradable resin compositions from the blends of the plasticizer of the invention with polylactic acid encompass compositions comprising:
a. about 50 to about 99.99% (w/w) of one or more biodegradable polylactic acid;
b. about 0.001 to about 40% (w/w) of one or more plasticizers;
c. about 0 to about 40% (w/w) of one or more of inorganic fillers;
d. about 0 to about 10% (w/w) of one or more of additives such as coupling agents, processing aids, compatibilizing agents, chain extenders, initiators, peroxides, impact modifiers and pigments.

In certain embodiments, the biodegradable thermoplastic polymer is selected from the grades of polylactic acid but not limited to injection molding, cast film extrusion, thermoforming, fiber, extrusion stretching, hot sealing, foaming and combinations thereof.

In certain embodiments, the biodegradable thermoplastic polymer is selected from the sub-families of polylactic acid, such as but not limited to PDLLA (poly DL-lactic acid), PLLA (poly(L-lactic acid), and PDLA (poly(D-lactic acid)).

In certain embodiments, the inorganic fillers include, but are not limited to, wollastonite, mica, clay, calcium carbonate, glass fiber, talc, aluminum silicate, zirconium oxide, sepiolite, gypsum and a combination thereof.

In certain embodiments, the invention encompasses methods of producing the biodegradable plasticizer composition in which ingredients are mixed and melt-blended together in a reactor vessel equipment or apparatus with agitation capability, at elevated temperatures for a time period of several minutes to several hours at each reaction stage.

In certain embodiments, the resin compositions of the plasticizer of the invention and polylactic acid encompass methods of production in which ingredients are mixed and melt-compounded together in a polymer processing equipment or apparatus selected from a batch mixer, a twin screw extruder or a single screw extruder and at elevated temperatures for a time period of several seconds to several minutes.

In certain embodiments, the biodegradable resin composition from blends of the plasticizer of the invention and polylactic acid can be used in consumer articles of any thickness and rigidity made by conventional polymer processing techniques comprising blown and cast film extrusion, compression molding, thermoforming and injection molding techniques.

The invention generally encompasses compositions and methods of manufacturing the biobased and biodegradable plasticizers, which include but not limited to, about 50 to about 90% (w/w) of one or more biodegradable and compostable lipids; about 0 to about 40% (w/w) of one or more acidifiers; about 0.01 to about 40% (w/w) of one or more of oxidizers; about 0 to about 10% (w/w) of one or more of stabilizer.

The method of production can be any of the following but not limited to these; In one embodiment, the reactants are mixed together in a reaction vessel and heated to a desired temperature for a certain period of time. In another embodiment, the acidifier is heated prior to the addition of lipid and the oxidizer. The lipid and oxidizer can be added slowly or at once. In another embodiment, the lipid and acidifier are heated prior to the addition of oxidizer. In another embodiment oxidizers are heated prior to addition of lipid and acidifier. In another embodiment, the lipid, acidifier and oxidizer are heated separately to the reaction temperature and mixed together. In another embodiment, the lipid, acidifier and oxidizer are agitated at room temperature for a prescribed period of time prior to heating to the desired temperature.

In one embodiment gaseous by-products are extracted and removed from the reaction vessel. In another embodiment, gaseous byproducts are condensed back to the reaction vessel.

In one embodiment, the reaction vessel could be made of heat and crack-resistant glassware, stainless steel, or high-temperature-resistant plastic equipped with an overhead stirrer or another mechanism for the agitation of the reagents. The reaction vessel could be open, closed or partially closed.

The reaction temperature could be in the range of 50-250° C. In one embodiment, the temperature was increased to the desired temperature and maintained throughout the reaction. In another embodiment, the temperature was gradually increased in step wise process to the desired temperature. In another embodiment temperature was increased to required temperature, maintained for a prescribed period and then changed to a different reaction temperature for a period of time.

The agitation could be in the range of 0-1000 RPM. In one embodiment, agitation is started at room temperature. In another embodiment, agitation is started after the reagents are heated to a desired temperature and maintained for a prescribed period. In one embodiment, agitation speed is constant throughout the reaction. In another embodiment, different agitation speeds are used at different stages of the synthesis. The reaction is continued until the desired consistency of the plasticizer is achieved for a period which could range from 0.5 to 36 hours. The reaction is either cooled down slowly or rapidly. In one embodiment, agitation is stopped after achieving the desired consistency and viscosity of the plasticizer. In another embodiment, agitation is continued after achieving the desired consistency and viscosity of the plasticizer for a period of 1 minute to a few hours.

In one embodiment, the plasticizer is purified or filtered immediately after synthesis. In one embodiment, the plasticizer is purified or filtered after synthesis and cooling down. In one embodiment, the plasticizer is used without purification.

The biodegradable resin compositions from the blends of the compostable plasticizer of the invention with polylactic acid can comprise of one or more of the biodegradable thermoplastic polyester; one or more of the plasticizer of the invention; optionally one or more of inorganic fillers, and optionally one or more of other additives.

The methods of manufacturing of the aforementioned resin composition combinations may be achieved using mixing and melt-compounding equipment with adjustable and controllable temperatures and mixing speeds, such as a single or twin screw extruder or a batch kneader.

### DETAILED DESCRIPTION OF INVENTION

To facilitate an understanding of the invention, it will be described more comprehensively herein below. However, the invention may be embodied in different forms and is not limited to the embodiments set forth herein. Rather, these embodiments are provided for the purpose of making the disclosure of the invention more thorough and comprehensive.

Unless otherwise defined, all technical and scientific terms used herein have the same meaning as those commonly understood by a person skilled in the art to which the present invention belongs. Terms used in the specification of the present invention are only for the purpose of describing specific embodiments, and are not intended to limit the present invention.

### Definitions

As used herein, “additive” could refer to material used to enhance a targeted property or function of material and/or composition, which could be in any form such as solid, liquid, powder, fiber, or crystal.

The prefix “bio” as used herein refers to a material that has been derived from a renewable biological resource.

The term “biobased” or “bio-based” refers to compositions that are derived from plant matter or animals instead of being made from petroleum or natural gas. Because these are animal or plant-based, there is a tendency to assume that the additive must be biodegradable. However, this is not the case for all bio-based compositions. The bio-based compositions of the invention can be designed to biodegrade in less than 6 months.

The term “biodegradable” refers to compositions of the invention that can biodegrade within 12 months in a compost environment in a non-toxic, environmentally compatible manner with no heavy metal nor PTFE content, and remaining soil-safe (i.e., lack of eco-toxins). The resin compositions of the invention biodegrade within 12 months. Compostable plastic is biodegradable, but not every plastic that is biodegradable is compostable. The resin compositions of the invention can be designed to be both biodegradable and compostable. As used herein, “biodegradable” compositions are engineered to biodegrade in compost, soil, or water.

The terms “blend” or “resin” as used herein interchangeably, refer to a homogeneous mixture of one or more plasticizers and one or more polylactic acids along with other ingredients.

The term “compostable” compositions refer to biodegradation into soil conditioning material (i.e., compost). In order for a plastic to be labeled as commercially “compostable” it should be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standards D6400 and D6868 outline the specifications that must be met in order to label a plastic as “industrial compostable”.

As used herein, “functional groups” could refer to moieties on the chemical structure of a material which can interact with other materials to form a type of bond or can be modified through techniques such as but not limited to chemical, physical, biological and thermal processes.

As used herein, “lipid” could refer to any material in a liquid or solid form, which could be either simple lipids, compound lipids, derived lipids or a combination thereof, used as the foundational ingredient in the production of the biobased plasticizer.

As used herein, “plasticizer” could refer to material used to enhance elongation, plasticity, flexibility, toughness or reduce brittleness of polymers. One of such polymers as used herein is polylactic acid, poly(lactic acid) or polylactide all abbreviated as PLA.

As used herein, “stabilizer” refers to any substance or additive in the form of a liquid or solid, that enhances the thermal stability, emulsification, viscosity or particle suspension in a liquid medium. These stabilizers could have functional groups which aid in the stabilization process such as but not limited to hydroxyls, carbonyl, carboxyls, phenols, epoxides and anhydrides.

The term “thermoplastic”, as used herein, refers to a polymer, which softens when heated, becomes moldable and pliable, and then solidifies when cooled.

As used herein, “wt. %”, “parts by mass (w/w)” or “parts by mass % (w/w)” refer to the percentage weight of an ingredient with respect to the total weight of a composition.

### Ingredients of the Invention

The present invention is concerned with the development of biobased and biodegradable plasticizer compositions that impart plasticization and toughening properties to polylactic acid when blended. In general, the biodegradable and compostable plasticizer compositions of the invention can be considered valid alternative materials to those produced from petroleum resources or those not of 100% biobased carbon content, and especially those produced using harsh and non-sustainable methods and materials.

The biodegradable and compostable polylactic acid of the biodegradable resin composition blends with the plasticizer of the invention can be derived from natural resources such as starch and sugar.

The biodegradable and compostable plasticizer mainly consists of one or more lipids, one or more oxidizers, optionally one or more acidifiers, and optionally one or more stabilizers.

The lipids encompass a vast array of molecules with varying functionalities and can be obtained from sources such as vegetables, nuts, grains, seeds, animals, etc. Examples of lipids include but are not limited to fats and oils, waxes (soy wax, stearate wax, bees wax, lanolin, chinese wax, spermaceti wax, carnauba wax), saturated and unsaturated fatty acids, triglycerides, triacylglycerols, phospholipids, glycolipids, glycerol and sphingosine, and can be sourced from animals by products and plants such as but not limited to soybean, peanut, vegetables, linseed, castor, palm, corn, olive, canola and pecan. Lipids can be used in their virgin or post modification form. Lipids can have or be saturated, mono unsaturated, polyunsaturated fatty acids, or a combination thereof. These fatty acids can include but are not limited to linoleic acid, stearidonic acid, erucic acid, oleic acid, linolenic acid, palmitic acid, palmitoleic acid, vaccenic acid, gondoic acid, nervonic acid, cetoleic acid, myristoleic acid, petroselinic acid, ximenic acid, etc.

Acidifiers can be organic acid, inorganic acid or a mixture thereof. It can be sourced from fully bio-based, partially bio-based, non-bio-based sources, or a combination thereof. Organic acids can include but are not limited to mono carboxylic acids, dicarboxylic acids, polycarboxylic acids and sulfonic acids such as acetic acid, propanoic acid, methanesulfonic acid, citric acid, benzoic acid. Inorganic acids can include but are not limited to sulfuric acid, boric acid, hydrofluoric acid, hydrochloric acid and nitric acid.

Oxidizers can include but are not limited to potassium permanganate, nitric acid, hydrogen peroxide, peracetic acid, potassium chlorate, nitrous oxide, bromine, ozone and fluorine.

Stabilizer can include but not limited to, calcium carbonate, calcium sulfate, calcium silicate, magnesium silicate, barium sulfate, or a combination thereof.

### Biodegradable Plasticizer Production

Lipids could encompass a range from 50-90% (w/w). Acidifiers could compass a range from 0-40% (w/w). Oxidizers could encompass a range from 0.01-40% (w/w). Stabilizer could encompass a range from 0-10% (w/w).

The method of production can be any of the following but not limited to these; In one embodiment, the reactants are mixed together in a reaction vessel and heated to a desired temperature for a certain period of time. In another embodiment, the acidifier is heated prior to the addition of the lipid and oxidizer. Lipid and oxidizer can be added slowly or at once. In another embodiment, lipid and acidifier are heated prior to the addition of oxidizer. In another embodiment, oxidizers are heated prior to addition of lipid and acidifier. In another embodiment, the lipid, acidifier and oxidizer are heated separately to the reaction temperature and mixed together. In another embodiment, the lipid, acidifier and oxidizer are agitated at room temperature for a prescribed period of time prior to heating to the desired temperature.

In one embodiment, gaseous by-products are extracted and removed from the reaction vessel. In another embodiment, gaseous byproducts are condensed back to the reaction vessel.

In one embodiment, the reaction vessel could be made of heat and crack-resistant glassware, stainless steel, or high-temperature-resistant plastic equipped with an overhead stirrer or another mechanism for the agitation of the reagents. The reaction vessel could be open, closed or partially closed.

The reaction temperature could be in the range of 50-250° C. In one embodiment, the temperature was increased to the desired temperature and maintained throughout the reaction. In another embodiment, the temperature was gradually increased in step wise process to the desired temperature. In another embodiment, temperature was increased to the required temperature, maintained for a prescribed period and then changed to a different reaction temperature for a period of time.

The reaction pressure could be in the range of 50 to 760 Torr (atmospheric pressure). In one embodiment, the vacuum is applied from the beginning and maintained throughout the reaction. In another embodiment, vacuum is applied after the reactant reaches reaction temperature. In another embodiment, the vacuum is applied for a certain period of time during the reaction.

The agitation could be in the range of 0-1000 RPM. In one embodiment, agitation is started at room temperature. In another embodiment agitation is started after the reagents are heated to a desired temperature and maintained for a prescribed period. In one embodiment agitation speed is constant throughout the reaction. In another embodiment the different agitation speeds are used at different stages of the synthesis. The reaction is continued until the desired consistency of the plasticizer is achieved for a period of 0.5 to 36 hours. The reaction is cooled down slowly or rapidly. In one embodiment, agitation is stopped after achieving the desired consistency and viscosity of the plasticizer. In another embodiment, agitation is continued after achieving the desired consistency and viscosity of the plasticizer for a period of 1 minute to a few hours.

In one embodiment, the plasticizer is purified or filtered immediately after synthesis. In one embodiment, the plasticizer is purified or filtered after synthesis and cooling down. In one embodiment, the plasticizer is used without purification or filtration.

In various embodiments, the viscosity of the resulting plasticizer of the invention can have consistencies of any thickness, ranging from as thin as vegetable oils, to as thick as heavy grease or paste-like consistency.

### Biodegradable Resin Composition Production

The invention generally requires further blending with one or more grades or classes of thermoplastic polyester, polylactic acids, to showcase its effectiveness as a toughening and plasticizing agent. These compositions and methods of manufacturing the biodegradable and compostable compositions include, but are not limited to, about 50 to about 99.99% (w/w) of one or more of the biodegradable thermoplastic polyester; about 0.001 to about 40% (w/w) of one or more of the plasticizer of the invention; about 0 to about 40% (w/w) of one or more of inorganic fillers; about 0 to about 10% (w/w) of one or more of additives such as coupling agents, processing aids, compatibilizing agents, chain extenders, initiators, peroxides, impact modifiers and pigments.

The manufacturing methods of the aforementioned biodegradable and compostable composition combinations may be achieved using mixing and melt-compounding equipment with adjustable and controllable temperatures and mixing speeds, such as a single or twin screw extruder or a batch kneader. In a batch kneader, the processing temperature profile may range from about 50 to about 250° C., and the processing time may be between about 1 to 60 minutes. Alternatively, in scenarios where single or twin screw extrusion is employed, the temperature profile may range from about 50 to about 250° C., and the screw speed may range from about 50 to about 500 rpm.

It should be noted that the processing conditions provided herein are not limiting and may vary based on other conditions such as ingredient ratios and processing equipment. The resulting product may be extruded into films, sheets or more rigid parts using conventional cast extrusion, blown film extrusion, injection molding, thermoforming or compression molding techniques. Alternatively, the resulting product may be pelletized or crushed into powder and then injection molded or compression molded into plastic parts of higher thicknesses or into test samples for determining various properties such as mechanical, physical and thermal. The extrusion, injection or compression temperature is typically within the range used in the melt-processing and compounding of the resins and ingredients.

The order of mixing of the ingredients to produce the biodegradable resin using any of the abovementioned processing techniques and equipment can involve premixing of all the ingredients such as the plasticizer, polyesters, fillers, and additives before being melt-compounded at a specified temperature and for a period of time. The polyester and plasticizer can be melt-compounded together for a specific time period and at a specific temperature, after which other ingredients are added. The polyester and filler can be melt-compounded together for a specific time period and at a specific temperature, after which other additives are added. The polyester, filler and plasticizer can be melt-compounded together for a specific time period and at a specific temperature, after which other additives are added. The polyester and other additives can be melt-compounded together for a specific time period and at a specific temperature, after which the plasticizer and/or filler are added. The abovementioned order of ingredient addition during melt-compounding of the resin composition are not limiting and can encompass any other combination or ingredient orders and processing techniques.

In certain embodiments, the resin composition exhibits an elongation at break of up to 10%, at a strain rate of 50 mm/min.

In certain embodiments, the resin composition exhibits an elongation at break of up to 20%, at a strain rate of 50 mm/min.

In certain embodiments, the resin composition exhibits an elongation at break of up to 40%, at a strain rate of 50 mm/min.

In certain embodiments, the resin composition exhibits an elongation at break of up to 60%, at a strain rate of 50 mm/min.

In certain embodiments, the resin composition exhibits an elongation at break of up to 90%, at a strain rate of 50 mm/min.

In certain embodiments, the resin composition exhibits an elongation at break of more than 90%, at a strain rate of 50 mm/min.

In certain embodiments, the resin composition exhibits impact strengths of up to 40% increase compared to that of the neat PLA.

In certain embodiments, the resin composition exhibits impact strengths of up to 50% increase compared to that of the neat PLA.

In certain embodiments, the resin composition exhibits impact strengths of up to 60% increase compared to that of the neat PLA.

In certain embodiments, the resin composition exhibits impact strengths of more than 60% increase compared to that of the neat PLA.

### Examples

PLA: A twin screw extruder was pre-heated with a temperature profile from 130 to 175° C. across all zones. 4000 g of PLA pellets were fed at a feeding rate of approximately 20 kg/h and at a screw speed of 100 rpm. The extrudates were collected in the form of resin strands, pelletized and stored in air tight containers. Samples were produced from the pellets for mechanical testing and analysis using an injection molding machine with a temperature profile from 160 to 180° C., a screw speed of 75 rpm and injection and back pressures of 0.8 and 0.4 MPa, respectively. The mechanical properties and melt flow index (MFI) of the resin and the injection molded samples were tested using a Universal testing machine (UTM) and a melt flow indexer according to ASTM methods. The results are detailed in Table 1.

Example 1: In synthesizing biodegradable plasticizer, 300 g of vegetable oil, 204 g of oxidizer and 102 g of acidifier were mixed and reacted in a 3 L atmosphere pressure reactor at temperatures below 200° C. for about 2 hours. After the reaction, the resulting plasticizer was allowed to cool down to room temperature.

For further processing, a twin screw extruder was pre-heated with a temperature profile from 130 to 175° C. across all zones. 3800 g of PLA pellets and 200 g of the synthesized plasticizer were premixed thoroughly in a bucket and then fed into the hopper of the extruder at a feeding rate of approximately 20 kg/h and extruded at a screw speed of 100 rpm. The extrudates were collected in the form of resin strands, pelletized and stored in air tight containers. Samples were produced from the pellets for mechanical testing and analysis using an injection molding machine with a temperature profile from 160 to 180° C., a dozing rate of 75 rpm and injection and back pressures of 0.8 and 0.4 MPa, respectively. The mechanical properties and MFI of the resin and the injection molded samples were tested using a UTM and a melt flow indexer according to ASTM methods. The results are detailed in Table 1.

Example 2: In synthesizing biodegradable plasticizer, 75 g of vegetable oil, 51 g of oxidizer and 3.19 g of acidifier were mixed in a 250 mL atmosphere pressure reactor at temperatures below 200° C. for about 2 hours. After the reaction, the plasticizer was allowed to cool down to room temperature.

For further processing, a micro-compounder batch mixer was pre-heated to a temperature of 185° C., with a melt temperature of 180° C. 190 g of PLA pellets and 10 g of the synthesized plasticizer were premixed thoroughly in a bowl and then 12 g of the premix was fed into the hopper of the micro-compounder with a screw speed of 100 rpm and processed for 2 mins. The micro-compounder's die was, then, opened and extrudates were collected using a melt transfer device heated to 180° C. and injected into sample test bars using a tabletop injection molding machine at an injection pressure of 10 bars and mold temperature of 23° C. Samples were produced for mechanical testing and analysis and the mechanical properties and MFI of the resin were tested using a UTM and a melt flow indexer according to ASTM methods. The results are detailed in Table 1.

Example 3: In synthesizing biodegradable plasticizer, 75 g of vegetable oil, 6.38 g of oxidizer and 3.19 g of acidifier were mixed in a 250 mL atmosphere pressure reactor at temperatures below 200° C. for about 2 hours. After the reaction, the plasticizer was allowed to cool to room temperature.

For further processing, a micro-compounder batch mixer was pre-heated to a temperature of 185° C., with a melt temperature of 180° C. 190 g of PLA pellets and 10 g of the synthesized plasticizer were premixed thoroughly in a bowl and then 12 g of the premix was fed into the hopper of the micro-compounder with a screw speed of 100 rpm and processed for 2 mins. The micro-compounder's die was, then, opened and extrudates were collected using a melt transfer device heated to 180° C. and injected into sample test bars using a tabletop injection molding machine at an injection pressure of 10 bars and mold temperature of 23° C. Samples were produced for mechanical testing and analysis and the mechanical properties and MFI of the resin were tested using a UTM and a melt flow indexer according to ASTM methods. The results are detailed in Table 1.

Example 4: In synthesizing biodegradable plasticizer, 300 g of vegetable oil, 204 g of oxidizer and 102 g of acidifier were mixed in a 3 L atmosphere pressure reactor at temperatures below 200° C. for about 2 hours. After the reaction, the plasticizer was allowed to cool down to room temperature.

For further processing, a twin screw extruder was pre-heated with a temperature profile from 130 to 175° C. across all zones. 2560 g of PLA pellets, 240 g of the synthesized plasticizer and 1200 g of mineral were premixed thoroughly in a bowl and then fed into the hopper of the extruder. The premix was fed at a feeding rate of approximately 20 kg/h and at a screw speed of 100 rpm. The extrudates were collected in the form of resin strands, pelletized and stored in air tight containers. Samples were produced from the pellets for mechanical testing and analysis using an injection molding machine with a temperature profile from 160 to 180° C., a screw speed of 75 rpm and injection and back pressures of 0.8 and 0.4 MPa, respectively. The mechanical properties and MFI of the resin and the injection molded samples were tested using a UTM and a melt flow indexer according to ASTM methods. The results are detailed in Table 2.

Example 5: A micro-compounder batch mixer was pre-heated to a temperature of 185° C., with a melt temperature of 180° C. 140 g of PLA pellets and 60 g of mineral were premixed thoroughly in a bowl and then 12 g of the premix was fed into the hopper of the micro-compounder with a screw speed of 200 rpm and processed for 2 mins. The micro-compounder's die was, then, opened and extrudates were collected using a melt transfer device heated to 180° C. and injected into sample test bars using a tabletop injection molding machine at an injection pressure of 10 bars and mold temperature of 23° C. Samples were produced for mechanical testing and analysis and the mechanical properties and MFI of the resin were tested using a UTM and a melt flow indexer according to ASTM methods. The results are detailed in Table 2.

Example 6: In synthesizing biodegradable plasticizer, 75 g of vegetable oil, 51 g of oxidizer and 25.5 g of acidifier were mixed in a 250 mL atmosphere pressure reactor at temperatures below 200° C. for about 2 hours. After the reaction, the plasticizer was allowed to cool to room temperature.

For further processing, a micro-compounder batch mixer was pre-heated to a temperature of 185° C., with a melt temperature of 180° C. 128 g of PLA pellets, 60 g of mineral and 12 g of the synthesized plasticizer were premixed thoroughly in a bowl and then 12 g of the premix was fed into the hopper of the micro-compounder with a screw speed of 200 rpm and processed for 2 mins. The micro-compounder's die was, then, opened and extrudates were collected using a melt transfer device heated to 180° C. and injected into sample test bars using a tabletop injection molding machine at an injection pressure of 10 bars and mold temperature of 23° C. Samples were produced for mechanical testing and analysis and the mechanical properties and MFI of the resin were tested using a UTM and a melt flow indexer according to ASTM methods. The results are detailed in Table 2.

Example 7: In synthesizing biodegradable plasticizer, 75 g of fatty acid, 51 g of oxidizer and 25.5 g of acidifier were mixed in a 250 mL atmosphere pressure reactor at temperatures below 200° C. for about 2 hours. After the reaction, the plasticizer was allowed to cool to room temperature.

For further processing, a micro-compounder batch mixer was pre-heated to a temperature of 185° C., with a melt temperature of 180° C. 128 g of PLA pellets, 60 g of mineral and 12 g of the synthesized plasticizer were premixed thoroughly in a bowl and then 12 g of the premix was fed into the hopper of the micro-compounder with a screw speed of 200 rpm and processed for 2 mins. The micro-compounder's die was, then, opened and extrudates were collected using a melt transfer device heated to 180° C. and injected into sample test bars using a tabletop injection molding machine at an injection pressure of 10 bars and mold temperature of 23° C. Samples were produced for mechanical testing and analysis and the mechanical properties and MFI of the resin were tested using a UTM and a melt flow indexer according to ASTM methods. The results are detailed in Table 2.

Example 8: In synthesizing biodegradable plasticizer, 75 g of fatty acid and 51 g of oxidizer were mixed in a 250 mL atmosphere pressure reactor at temperatures below 200° C. for about 1.5 hours. After the reaction, the plasticizer was allowed to cool to room temperature.

For further processing, a micro-compounder batch mixer was pre-heated to a temperature of 185° C., with a melt temperature of 180° C. 128 g of PLA pellets, 60 g of mineral and 12 g of the synthesized plasticizer were premixed thoroughly in a bowl and then 12 g of the premix was fed into the hopper of the micro-compounder with a screw speed of 200 rpm and processed for 2 mins. The micro-compounder's die was, then, opened and extrudates were collected using a melt transfer device heated to 180° C. and injected into sample test bars using a tabletop injection molding machine at an injection pressure of 10 bars and mold temperature of 23° C. Samples were produced for mechanical testing and analysis and the mechanical properties and MFI of the resin were tested using a UTM and a melt flow indexer according to ASTM methods. The results are detailed in Table 2.

TABLE 1
Mechanical properties of PLA blends with biobased plasticizers.

| | | Exam- | Exam- | Exam- |
|---|---|---|---|---|
| Properties | PLA | ple 1 | ple 2 | ple 3 |
| Tensile Strength (Stress at | 70.8 | 65 | 62 | 60 |
| Yield) (MPa) | | | | |
| Young's Modulus (MPa) | 3141 | 3105 | 3151 | 3315 |
| Strain at Yield (%) | 2.6 | 2.4 | 2.5 | 1.7 |
| Strain at Break (%) | 3 | 12 | 73 | 107 |
| Tensile Toughness | 341 | 620 | 2713 | 3725 |
| (N · m⁻²) | | | | |
| Impact Strength (J/m) | 37 | 44 | 60 | 61 |
| MFI @ 190° C., 2.16 kg - | 3.7 | 7.6 | 15 | 20 |
| g/10 min | | | | |

TABLE 2
Mechanical properties of PLA composites
blended with biobased plasticizers.

| | Exam- | Exam- | Exam- | Exam- | Exam- |
|---|---|---|---|---|---|
| Properties | ple 4 | ple 5 | ple 6 | ple 7 | ple 8 |
| Tensile Strength (Stress | 34 | 72 | 40 | 50 | 40 |
| at Yield) (MPa) | | | | | |
| Young's Modulus (MPa) | 4050 | 7000 | 4460 | 5033 | 5599 |
| Strain at Yield (%) | 1.5 | 1.6 | 2 | 1 | 1 |
| Strain at Break (%) | 45 | 1.6 | 34 | 32 | 64 |
| MFI @ 190° C., | 44.6 | 18 | 39 | 48 | 59 |
| 2.16 kg - g/10 min | | | | | |

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A synthesized biobased and biodegradable plasticizer composition comprising:
i. about 50 to about 90% (w/w) of one or more of biobased and biodegradable lipids;
ii. about 0 to about 40% (w/w) of one or more of acidifiers;
iii. about 0.01 to about 40% (w/w) of one or more of oxidizers;
iv. about 0 to about 10% (w/w) of one or more of stabilizers;
Wherein, the composition imparts plasticization, flexibility and toughness to polylactic acid when blended using conventional polymer processing techniques.

2. A biodegradable resin composition comprising:
i. about 50 to about 99.99% (w/w) of one or more biodegradable polylactic polyester;
ii. about 0.001 to about 40% (w/w) of one or more of the biodegradable plasticizer of the invention;
iii. about 0 to about 40% (w/w) of one or more of inorganic fillers;
iv. about 0 to about 10% (w/w) of one or more of additives such as coupling agents, compatibilizing agents, chain extenders, initiators, peroxides, impact modifiers and pigments.

3. A biodegradable resin composition of claim 2, where it shows a minimum increase of about 100, 90, 20% in elongation at break, tensile toughness and impact strength, respectively, in comparison to virgin polylactic acid.

4. The biodegradable resin composition of claim 2, where the biodegradable polylactic polyester comprises one or more of any optical isomers and stereocomplexes of polylactic acid selected from PDLLA (poly DL-lactic acid), PLLA (poly(L-lactic acid), and PDLA (poly(D-lactic acid)), and combinations thereof with any molecular weight suitable for conventional plastic processing techniques comprising injection molding, cast film extrusion, thermoforming, fiber, blow molding, profile extrusion, hot sealing, foaming and combinations thereof.

5. The method of production of biobased and biodegradable plasticizer of claim 1 where it consists of mixing reactants in a heat and corrosion resistant reaction vessel and heating to a temperature in the range of 50-250° C. for a period of 0.5 to 36 hours. The agitation is in the range of 0-1000 RPM and the vessel is open, partially open or closed.

6. The biobased and biodegradable plasticizer composition of claim 1, wherein the lipids are obtained from vegetables, nuts, grains, seeds, animals, or combinations thereof, wherein the lipid is selected from the group consisting of saturated and unsaturated fatty acids, triglycerides, triacylglycerols, phospholipids, fats (lard and butter, and oils), waxes (soy wax, stearate wax, bees wax, lanolin, chinese wax, spermaceti wax, carnauba wax), glycolipids, sphingosine, vegetable oil, natural oil, corn oil, soybean oil, linseed oil, sunflower oil, canola oil, coconut oil, peanut oil, castor oil, palm oil, linoleic acid, stearidonic acid, erucic acid, oleic acid, linolenic acid, palmitic acid, palmitoleic acid, erucic acid, vaccenic acid, or any combinations thereof.

7. The biobased and biodegradable plasticizer composition of claim 1, where the stabilizer is an inorganic mineral comprising wollastonite, mica, clay, calcium carbonate, glass fiber, talc, aluminum silicate, zirconium oxide, sepiolite, gypsum, and combinations thereof.

8. The biobased and biodegradable and compostable plasticizer composition of claim 1, where the acidifier is an organic acid comprising lactic acid, formic acid, stearic acid, tannic acid, malic acid, citric acid, aspartic acid, ascorbic acid, acetic acid, tartaric acid, and combinations thereof.

9. The biobased and biodegradable and compostable plasticizer composition of claim 1, where the oxidizer is an organic or inorganic acid, or a peroxide comprising potassium permanganate, nitric acid, hydrogen peroxide, peracetic acid, zinc peroxide, perchlorate, potassium chlorate, nitrous oxide, bromine, ozone and fluorine, and combinations thereof.

10. The biodegradable resin composition of claim 2, wherein the composition exhibits more than 90% disintegration in less than about 12 weeks, and wherein the composition exhibits more than 90% biodegradation in less than 180 days under thermophilic temperature conditions.

11. A method of producing the biodegradable resin composition of claim 2, in which components are mixed and melt-compounded together in a polymer processing equipment or apparatus comprising a batch mixer, a twin screw extruder or single screw extruder at elevated temperatures for a time period of several seconds to several minutes.

12. The biobased and biodegradable plasticizer composition of claim 1, where the bio-based carbon content of the composition is 100%.

13. The biodegradable resin composition of claim 2, where the bio-based carbon content of the composition is 100%.

14. The biodegradable resin composition of claim 2, for use in articles of any thickness and rigidity using conventional polymer processing techniques comprising blown and cast film extrusion, compression molding and injection molding techniques.
